(19) United States
(12) Patent Application Publication
(10) Pub. No.: US 2013/0000206 A1
(43) Pub. Date: Jan. 3, 2013

(54) SHAPE MEMORY ALLOY ACTUATOR WITH DOUBLE ENDED FORCE MULTIPLICATION

(75) Inventors: James C. O'Kane, Shelby Township, MI (US); Phillip C. Storck, III, Chesterfield, MI (US)

(73) Assignee: GM GLOBAL TECHNOLOGY OPERATIONS LLC, Detroit, MI (US)

(21) Appl. No.: 13/173,240

(22) Filed: Jun. 30, 2011

(51) Int. Cl. E06B 7/16; F03G 7/06

(52) U.S. Cl. 49/472; 60/527

(57) ABSTRACT

An assembly includes a first member and a second member spaced from and the first member, with the first member and the second member moveable relative to each other. A shape memory alloy actuator couples the second member to the first member. The shape memory alloy actuator includes a first end and a second end, both attached to the first member, with the shape memory alloy wrapped around a guide device to redirect the path of the shape memory alloy actuator. Having both the first end and the second end attached to the second member doubles the tensile force applied to the second member when the shape memory alloy actuator contracts.

### TECHNICAL FIELD

The invention generally relates to an assembly having a shape memory alloy actuator for moving a second member relative to a first member.

### BACKGROUND

Shape memory alloy elements are being incorporated into various assemblies to act as an actuator for moving a first member relative to a second member. The shape memory alloy actuator typically includes a wire coupled to the first member and the second member. The shape memory alloy actuator contracts in response to an actuation signal, such as an electrical signal, thereby causing the first member and/or the second member to move toward the other.

### SUMMARY

An assembly is provided. The assembly includes a first member and a second member. The second member is spaced from the first member, and is disposed opposite the first member across an axis. The second member is moveable relative to the first member. The assembly further includes a shape memory alloy actuator. The shape memory alloy actuator includes a first end and a second end. Each of the first end and the second end of the shape memory alloy actuator is coupled to the second member. The shape memory alloy actuator is coupled to the first member at a location disposed along the shape memory alloy actuator between the first end and the second end of the shape memory alloy actuator. The shape memory alloy actuator contracts from an initial shape in response to an actuation signal to move the second member toward the first member, and returns to the initial shape upon removal of the actuation signal to allow the second member to move away from the first member.

A door assembly for a vehicle is also provided. The door assembly includes a frame. A seal module is spaced from the frame and disposed opposite the frame across an axis. The seal module is moveable relative to the frame. The door assembly further includes a shape memory alloy actuator. The shape memory alloy actuator includes a first end and a second end. Each of the first end and the second end of the shape memory alloy actuator is coupled to the frame. The shape memory alloy actuator is coupled to the seal module at a location disposed along the shape memory alloy actuator between the first end and the second end of the shape memory alloy actuator. The shape memory alloy actuator is at least partially wrapped around a guide device such that the guide device redirects a path of the shape memory alloy actuator to define a first segment including the first end of the shape memory alloy actuator and a second segment including the second end of the shape memory alloy actuator. A first linkage interconnects the first end of the shape memory alloy actuator and the frame, and a second linkage interconnects the second end of the shape memory alloy actuator and the frame. The shape memory alloy actuator contracts from an initial shape in response to an actuation signal to move the seal module toward the frame, and returns to the initial shape upon removal of the actuation signal to allow the seal module to move away from the frame. A return device interconnects the frame and the seal module, and is configured to bias the seal module away from the frame.

Accordingly, neglecting friction, the force applied to the second member, e.g., the seal module, is doubled because both the first end and the second end of the shape memory alloy element are attached to the second member, with the shape memory alloy actuator wrapped around the guide device. Accordingly, when the shape memory alloy actuator contracts, thereby creating a tensile force within the shape memory alloy device, the tensile force is applied to the second member through both the first end and the second end of the shape memory alloy actuator, thereby doubling the force applied.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of an assembly showing a shape memory alloy actuator moveably coupling a first member relative to a second member.

FIG. 2 is a schematic diagram of an alternative embodiment of the assembly.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

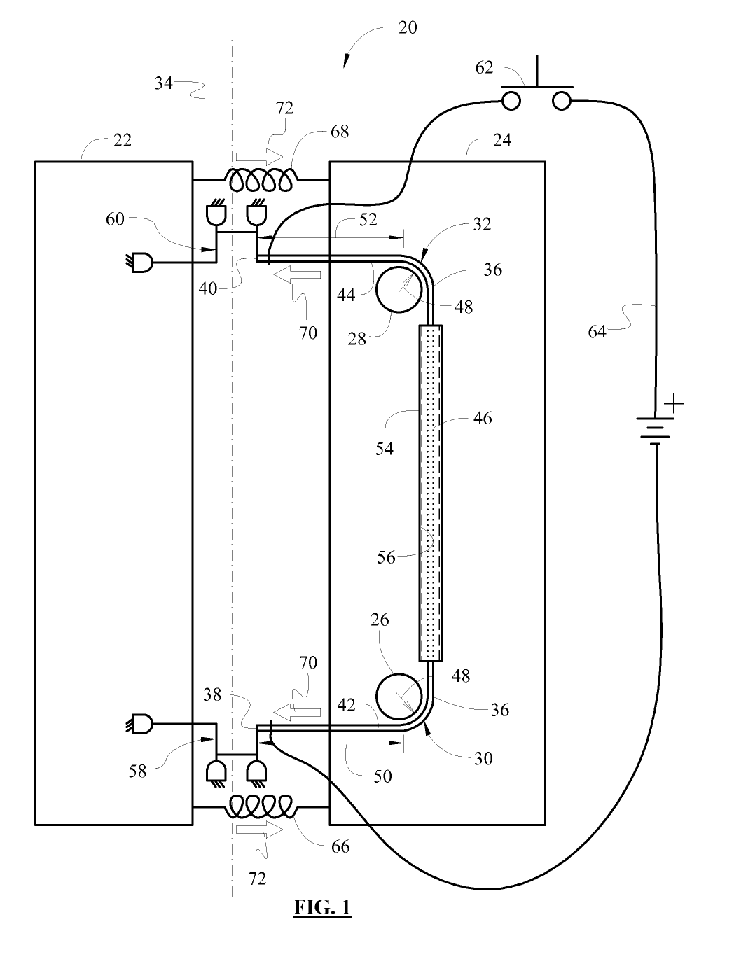

Referring to FIG. 1, wherein like numerals indicate like parts throughout, an assembly is generally shown at 20. The assembly 20 includes a first member 22 and a second member 24. The assembly 20 may include but is not limited to a door assembly for a vehicle. If the assembly 20 includes the door assembly, then the first member 22 may include a frame or substrate of the door assembly 20, and the second member 24 may include a retractable seal module for sealing between the frame of the door assembly and a body of the vehicle.

The second member 24 includes a guide device 26, 28. Preferably, the guide device 26, 28 includes a cylindrical roller rotatably attached to the second member 24. However, the guide device 26, 28 may alternatively include any shape and/or configuration capable of redirecting a shape memory alloy actuator 36 (described in greater detail below), and may be fixedly attached to the second member 24. As shown, the guide device 26, 28 includes a first guide device 26 disposed at a first location 30 on the second member 24, and a second guide device 28 disposed at a second location 32 on the second member 24. However, the guide device 26, 28 may include any number of devices. As shown, the first location 30 and the second location 32 are spaced from each other along an axis 34, and are transversely spaced equidistant from the axis 34. However it should be appreciated that the first location 30 and the second location 32, and therefore the first guide device 26 and the second guide device 28, may be positioned relative to the axis 34 in some other orientation not shown or described herein.

The second member 24 is laterally spaced from the first member 22, and is disposed opposite the first member 22 across the axis 34. As shown and described herein, the second member 24 is moveable relative to the first member 22. However, it should be appreciated that the relative movement between the first member 22 and the second member 24 may be reversed such that the first member 22 is moveable relative to the second member 24.

As noted above, the assembly 20 includes a shape memory alloy actuator 36. The shape memory alloy actuator 36 may include but is not limited to a flexible wire or ribbon that is capable of providing a high tensile force, while incapable of providing a significant tension force. The shape memory alloy actuator 36 is coupled to the first member 22 and the second member 22 in a manner that is configured to multiply the tension force generated by the shape memory alloy actuator 36 during contraction thereof.

The shape memory alloy actuator 36 includes and is manufactured from a shape memory alloy. Suitable shape memory alloys can exhibit a one-way shape memory effect, an intrinsic two-way effect, or an extrinsic two-way shape memory effect depending on the alloy composition and processing history. The two phases that occur in shape memory alloys are often referred to as martensite and austenite phases. The martensite phase is a relatively soft and easily deformable phase of the shape memory alloys, which generally exists at lower temperatures. The austenite phase, the stronger phase of shape memory alloys, occurs at higher temperatures. Shape memory materials formed from shape memory alloy compositions that exhibit one-way shape memory effects do not automatically reform, and depending on the shape memory material design, will likely require an external mechanical force to reform the shape orientation that was previously exhibited. Shape memory materials that exhibit an intrinsic shape memory effect are fabricated from a shape memory alloy composition that will automatically reform themselves.

The temperature at which the shape memory alloy remembers its high temperature form when heated can be adjusted by slight changes in the composition of the alloy and through heat treatment. In nickel-titanium shape memory alloys, for example, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing the shape memory material with shape memory effects as well as high damping capacity. The inherent high damping capacity of the shape memory alloys can be used to further increase the energy absorbing properties.

Suitable shape memory alloy materials include without limitation nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-platinum based alloys, iron-palladium based alloys, and the like. The alloys can be binary, ternary, or any higher order so long as the alloy composition exhibits a shape memory effect, e.g., change in shape orientation, damping capacity, and the like. For example, a nickel-titanium based alloy is commercially available under the trademark NITINOL from Shape Memory Applications, Inc.

The shape memory alloy actuator 36 includes a first end 38 and a second end 40. Each of the first end 38 and the second end 40 of the shape memory alloy actuator 36 is coupled to the first member 22, i.e., the first end 38 of the shape memory alloy actuator 36 is coupled to the first member 22 and the second end 40 of the shape memory alloy actuator 36 is also coupled to the first member 22.

The shape memory alloy actuator 36 is coupled to the second member 24 at a location disposed along the shape memory alloy actuator 36 between the first end 38 and the second end 40 of the shape memory alloy actuator 36. The shape memory alloy actuator 36 is coupled in such a way as to not be fixed to the second member 24, moving freely in the cable housing 54 described in greater detail below. As shown, the location at which the shape memory alloy actuator 36 is coupled to the second member 24 includes the first location 30 and the second location 32 described above. More specifically, the first guide device 26 and the second guide device 28 couple the shape memory alloy actuator 36 to the second member 24. The shape memory alloy actuator 36 is at least partially wrapped around the guide device 26, 28. More specifically, the shape memory alloy actuator 36 is at least partially wrapped around the first guide device 26 and the second guide device 28.

The guide device 26, 28 is configured to redirect a path of the flexible shape memory alloy actuator 36. The guide device 26, 28 redirects the shape memory alloy actuator 36 to define a first segment 42 and a second segment 44 extending transverse relative to the axis 34. The first segment 42 includes the first end 38 of the shape memory alloy actuator 36, and the second segment 44 includes the second end 40 of the shape memory alloy actuator 36. Accordingly, it should be appreciated that the guide device 26, 28 redirects the path of the shape memory alloy actuator 36 to allow both the first end 38 and the second end 40 of the shape memory alloy actuator 36 to be coupled to the first member 22. As shown, the first guide device 26 and the second guide device 28 are spaced to define a third segment 46 of the shape memory alloy actuator 36 disposed between the first guide device 26 and the second guide device 28. While the guide device 26, 28 is shown to include both the first guide device 26 and the second guide device 28, thereby allowing the first segment 42 and the second segment 44 to be spaced from each other along the axis 34 while simultaneously directing the first segment 42 and the second segment 44 of the shape memory alloy actuator 36 perpendicularly across the axis 34 to the first member 22, it should be appreciated that the guide device 26, 28 only requires a single guide device 26, 28 in order to redirect the path of the shape memory alloy actuator 36.

As noted above, the guide device 26, 28 preferably includes a cylindrical roller rotatably mounted to the second member 24. The guide device 26, 28 defines a radius 48 having sufficient size to prevent kinks and/or sharp bends in the shape memory alloy actuator 36. The size of the radius 48 is dependent upon the diameter and/or thickness of the shape memory alloy actuator 36. However, it should be appreciated that the guide device 26, 28 may not provide an axis of rotation and may alternatively be configured from a low friction material that redirects the tension in the shape memory alloy actuator 36 by allowing the shape memory alloy actuator to slide over and across the low friction material.

The first end 38 of the shape memory alloy actuator 36 is spaced from the first location 30 a first distance 50. The second end 40 of the shape memory alloy actuator 36 is spaced from the second location 32 a second distance 52. Preferably, the first distance 50 is equal to the second distance 52. However, it should be appreciated that the first distance 50 may differ from the second distance 52.

The assembly 20 may further include a cable housing 54. The cable housing 54 is secured to the second member 24, between the first guide device 26 and the second guide device 28. The cable housing 54 defines a longitudinal passage 56 therethrough. The shape memory alloy actuator 36 is at least partially disposed within and moveable relative to the longitudinal passage 56 of the cable housing 54, with the cable housing 54 providing protection to the shape memory alloy actuator 36 along the third segment 46 of the shape memory alloy actuator 36. It should be appreciated that the cable housing 54 may not be required if the shape memory alloy actuator 36 is positioned in such a way that the path between the first guide device 26 and the second guide device 28 is a straight line. Furthermore, it should be appreciated that the cable housing 54 provides for a configuration of the guide devices 26, 28 which may not be position along a linear axis. The ends of the cable housing 54 may or may not be fixed to the second member 24.

The shape memory alloy actuator 36 contracts from an initial shape in response to an actuation signal. The shape memory alloy actuator 36 contracts to move the second member 24 toward the first member 22, as indicated by arrows 70. The shape memory alloy actuator 36 returns to the initial shape upon removal of the actuation signal, thereby allowing the second member 24 to move away from the first member 22.

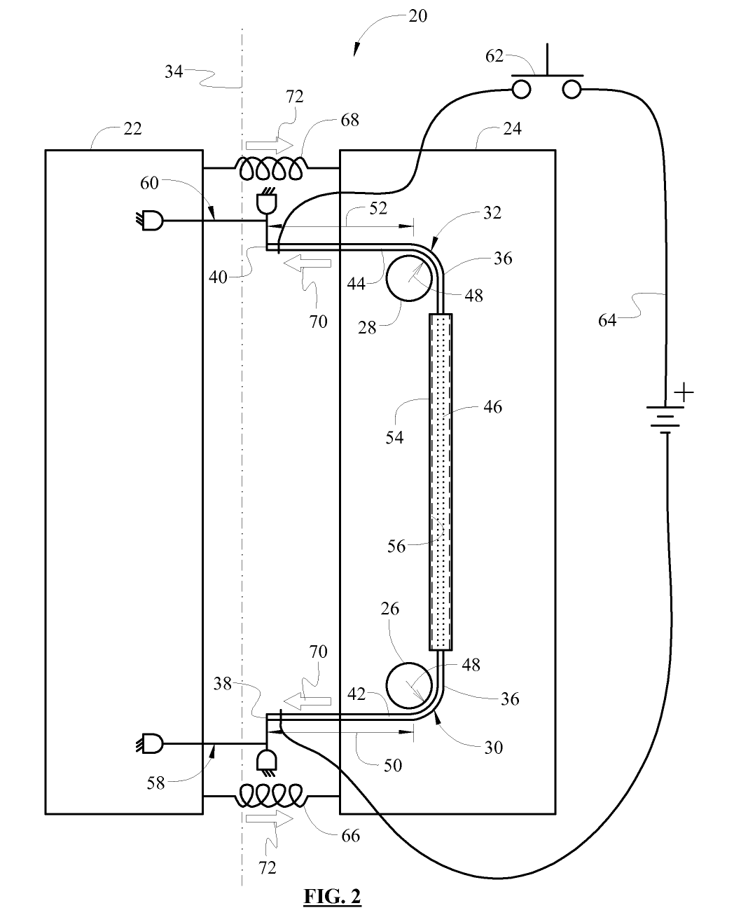

The assembly 20 may further include a first linkage 58 and a second linkage 60. The first linkage 58 interconnects the first end 38 of the shape memory alloy actuator 36 and the first member 22. The second linkage 60 interconnects the second end 40 of the shape memory alloy actuator 36 and the first member 22. The linear movement caused by the contraction of the shape memory alloy actuator 36 moves the first linkage 58 and the second linkage 60 to move the second member 24 toward the first member 22. The first linkage 58 and the second linkage 60 may each include, but are not limited to, one of a four bar linkage (shown in FIG. 1), a bell crank linkage (shown in FIG. 2) or a cam and follower linkage. It should be appreciated that no linkage is required if the first end 38 and the second end 40 are directly connected to the first member 22.

The first linkage 58 and the second linkage 60 may be configured to amplify or increase the linear movement of the shape memory alloy actuator 36. For example, if the first end 38 and/or the second end 40 of the shape memory alloy actuator 36 move a distance X upon the shape memory alloy contracting, then the linkage may be configured to move the second member 24 4× (four times the distance). Alternatively, the first end 38 and the second end 40 of the shape memory alloy actuator 36 may be directly attached to the first member 22. It should be appreciated that the first linkage 58 and the second linkage 60 may be configured to amplify or increase the force applied by the shape memory alloy actuator 36. The geometry of the first linkage 58 and the second linkage 60 may be configured differently to effect a combination of force and/or displacement amplification.

The activation signal may include any suitable type of signal, and is dependent upon the shape memory alloy actuator 36. For example, the activation signal may include but is not limited to a heat signal, a magnetic signal, an electrical signal, a pneumatic signal, a mechanical signal, and combinations comprising at least one of the foregoing signals, with the particular activation signal dependent on the materials and/or configuration of the active material. For example, a heat signal or an electric signal may be applied for changing the property of the shape memory alloy actuator 36. As shown, the shape memory alloy actuator 36 is electrically coupled to a control switch 62 through a control wire 64. Closing the control switch 62 sends an electrical current or signal through the control wire 64 to the shape memory alloy actuator 36, causing the shape memory alloy actuator 36 to contract from the initial shape of the shape memory alloy actuator 36. Opening the control switch 62 stops the electrical current or signal, thereby allowing the shape memory alloy actuator 36 to return to the initial shape.

The assembly 20 further includes a return device 66, 68. The return device 66, 68 interconnects the first member 22 and the second member 24. The return device 66, 68 is configured to bias the second member 24 away from the first member 22, as indicated by arrows 72. The return device 66, 68 may include but is not limited to an expansion spring or other similar device disposed between the first member 22 and the second member 24. As shown, the return device 66, 68 includes a first return device 66 disposed adjacent the first end 38 of the shape memory alloy actuator 36, and a second return device 68 disposed adjacent the second end 40 of the shape memory alloy actuator 36. It should be appreciated that the return force applied by the first return device 66 and the second return device 68 may be accomplished by different means and could be applied at a single point or a force distributed along the length of the interface between the first member 22 and the second member 24, which acts to separate the assembly 20. Although represented in the Figures as a spring, this force may be applied by any device such as but not limited to a pneumatic device, gravity, a deformed polymer device, etc.

In operation, in order to move the second member 24 toward the first member 22, the control switch 62 is closed to provide the shape memory alloy actuator 36 with the activation signal, i.e., an electrical current, thereby causing the shape memory alloy actuator 36 to contract. As the shape memory alloy actuator 36 contracts, both the first end 38 and the second end 40 of the shape memory alloy actuator 36 are drawn toward the second member 24. Because both the first end 38 and the second end 40 of the shape memory alloy actuator 36 are coupled to the first member 22, both the first end 38 and the second end 40 of the shape memory alloy actuator 36 pull on or apply a tensile force to the first member 22. This provides double the tensile force or pulling force when compared to an arrangement in which one of the first end 38 and the second end 40 is attached to the first member 22 and the other of the first end 38 and the second end 40 is attached to the second member 24. Because both the first end 38 and the second end 40 of the shape memory alloy actuator 36 are coupled to the first member 22, the linear distance that the first end 38 and the second end 40 of the shape memory actuator moves is proportional to the length of the first segment 42, the length of the second segment 44, and the length of the third segment 46 of the shape memory alloy actuator 36 respectively. A longer length of the first segment 42, the second segment 44 and the third segment will provide greater linear movement of the first end 38 and the second end 40 of the shape memory alloy actuator 36. Furthermore, different lengths between the first segment 42, the second segment 44 and the third segment 46 will provide different linear movements between the first end 38 and the second end 40 of the shape memory alloy actuator 36. In order to move the second member 24 back, the control switch 62 is opened, thereby allowing the shape memory alloy actuator 36 to return to the initial shape thereof, whereupon the return device 66, 68 biases the second member 24 away from the first member 22.

While the best modes for carrying out the invention have been described in detail, those familiar with the art to which this invention relates will recognize various alternative designs and embodiments for practicing the invention within the scope of the appended claims.

1. An assembly comprising:
a first member;
a second member spaced from the first member and disposed opposite the first member across an axis, wherein the second member is moveable relative to the first member; and
a shape memory alloy actuator having a first end and a second end, wherein each of the first end and the second end of the shape memory alloy actuator is coupled to the first member, and the shape memory alloy actuator is coupled to the second member at a location disposed along the shape memory alloy actuator between the first end and the second end of the shape memory alloy actuator;
wherein the shape memory alloy actuator contracts from an initial shape in response to an actuation signal to move the second member toward the first member, and returns to the initial shape upon removal of the actuation signal to allow the second member to move away from the first member.

2. An assembly as set forth in claim 1 wherein the second member includes a guide device configured to redirect a path of the shape memory alloy actuator.

3. An assembly as set forth in claim 1 wherein the shape memory alloy actuator is coupled to the first member and the second member in a manner configured to multiply a tension force generated by the shape memory alloy actuator during contraction thereof.

4. An assembly as set forth in claim 2 wherein the guide device redirects the shape memory alloy actuator to define a first segment and a second segment extending transverse relative to the axis.

5. An assembly as set forth in claim 4 wherein the shape memory alloy actuator is at least partially wrapped around the guide device, wherein the guide device defines a radius having sufficient size to prevent kinks in the shape memory alloy.

6. An assembly as set forth in claim 5 wherein the guide device includes a cylindrical roller rotatably attached to the first member.

7. An assembly as set forth in claim 5 wherein the location at which the shape memory alloy actuator is coupled to the second member includes a first location and a second location spaced from the first location along the axis.

8. An assembly as set forth in claim 7 wherein the guide device includes a first guide device disposed at the first location and a second guide device disposed at the second location, wherein the first guide device and the second guide device are spaced to define a third segment of the shape memory alloy actuator disposed between the first guide device and the second guide device.

9. An assembly as set forth in claim 8 further comprising a cable housing secured to the second member between the first guide device and the second guide device, and defining a longitudinal passage therethrough, wherein the shape memory alloy actuator is at least partially disposed within and moveable relative to the longitudinal passage of the cable housing.

10. An assembly as set forth in claim 7 wherein the first end of the shape memory alloy actuator is spaced from the first location a first distance, and wherein the second end of the shape memory alloy actuator is spaced from the second location a second distance.

11. An assembly as set forth in claim 10 wherein the first distance is equal to the second distance.

12. An assembly as set forth in claim 1 further comprising a first linkage interconnecting the first end of the shape memory alloy actuator and the first member, and a second linkage interconnecting the second end of the shape memory alloy actuator and the first member.

13. An assembly as set forth in claim 12 wherein linear movement of the shape memory alloy actuator moves the first linkage and the second linkage to move the second member toward the first member, wherein the first linkage and the second linkage amplify the linear movement of the shape memory alloy actuator.

14. An assembly as set forth in claim 12 wherein the first linkage and the second linkage each include one of a four bar linkage, a bell crank linkage or a cam and follower linkage.

15. An assembly as set forth in claim 1 further comprising a return device interconnecting the first member and the second member and configured for biasing the second member away from the first member.

16. An assembly as set forth in claim 15 wherein the return device includes a first return device disposed adjacent the first end of the shape memory alloy actuator, and a second return device disposed adjacent the second end of the shape memory alloy actuator.

17. An assembly as set forth in claim 15 wherein the return device includes an expansion spring.

18. A door assembly for a vehicle, the door assembly comprising:
a frame;
a seal module spaced from the frame and disposed opposite the frame across an axis, wherein the seal module is moveable relative to the frame;
a shape memory alloy actuator having a first end and a second end, wherein each of the first end and the second end of the shape memory alloy actuator is coupled to the frame, and the shape memory alloy actuator is coupled to the seal module at a location disposed along the shape memory alloy actuator between the first end and the second end of the shape memory alloy actuator;
wherein the shape memory alloy actuator is at least partially wrapped around a guide device such that the guide device redirects a path of the shape memory alloy actuator to define a first segment including the first end of the shape memory alloy actuator and a second segment including the second end of the shape memory alloy actuator;
a first linkage interconnecting the first end of the shape memory alloy actuator and the frame;
a second linkage interconnecting the second end of the shape memory alloy actuator and the frame;
wherein the shape memory alloy actuator contracts from an initial shape in response to an actuation signal to move the seal module toward the frame, and returns to the initial shape upon removal of the actuation signal to allow the seal module to move away from the frame; and
a return device interconnecting the frame and the seal module and configured for biasing the seal module away from the frame.

19. A door assembly as set forth in claim 18 wherein the location at which the shape memory alloy actuator is coupled to the seal module includes a first location and a second location spaced from the first location along the axis, wherein the guide device includes a first guide device disposed at the first location and a second guide device disposed at the second location, and wherein the first guide device and the second guide device are spaced to define a third segment of the shape memory alloy actuator disposed between the first guide device and the second guide device.

20. A door assembly as set forth in claim 18 wherein the first linkage and the second linkage each include one of a four bar linkage, a bell crank linkage or a cam and follower linkage, and wherein linear movement of the shape memory alloy actuator moves the first linkage and the second linkage to move the seal module toward the frame, wherein the first linkage and the second linkage amplify the linear movement of the shape memory alloy actuator.
